(19) United States
(12) Patent Application Publication
(10) Pub. No.: US 2013/0126653 A1
(43) Pub. Date: May 23, 2013

(54) REEL

(71) Applicant: FUJIFILM CORPORATION, Tokyo (JP)

(72) Inventor: Yasuhiro MORI, Odawara-shi (JP)

(73) Assignee: FUJIFILM CORPORATION, Tokyo (JP)

(21) Appl. No.: 13/738,986

(22) Filed: Jan. 10, 2013

Related U.S. Application Data
(63) Continuation of application No. PCT/JP2011/063176, filed on Jun. 8, 2011.

(30) Foreign Application Priority Data
Jul. 30, 2010 (JP) 2010-172790

(51) Int. Cl. G11B 23/037; G11B 15/32

(52) U.S. Cl. CPC G11B 23/037
USPC 242/349

(57) ABSTRACT

There is provided a reel including: a substantially cylindrical bottomed reel hub, around an outer peripheral surface of which a recording tape can be wound; a reel gear that is formed at a bottom section of the reel hub and is configured to mesh with a drive gear of a winding device that winds the recording tape around the reel hub; and a stationary portion that is formed at the bottom section of the reel hub and is configured to be fixed by a fastener to a fastening portion formed at a rotating member of a drive device.

### CROSS-REFERENCE TO RELATED APPLICATIONS

This application is a continuation application of International Application No. PCT/JP/2011/063176, filed Jun. 8, 2011, the disclosure of which is incorporated herein by reference. Further, this application claims priority from Japanese Patent Application No. 2010-172790, filed Jul. 30, 2010, the disclosure of which is incorporated by reference herein.

### BACKGROUND

1. Technical Field

The present invention relates to a reel embedded in such a manner that the reel cannot be demounted from a drive device.

2. Related Art

Heretofore, a recording tape cartridge has been known in which a recording tape such as a magnetic tape or the like, which is used primarily as a data recording/replaying medium (data backup) for computers and the like, is wound on a reel and this reel is singly accommodated in a case (for example, see Japanese Patent Application Laid-Open (JP-A) No. 2010-79989).

When this recording tape cartridge is mounted at a drive device, the recording tape is unwound from the reel, and the recording tape is wound onto a winding reel of the drive device. Then information is written to/read from the recording tape by a recording/replay head of the drive device.

However, in this system, because the recording tape cartridge is removable from the drive device, security measures for the recording tape cartridge (i.e., the information recorded on the recording tape) are necessary. Accordingly, immediately disposing a reel inside a drive device in such a manner that the reel cannot be demounted has been considered. In this case, however, attachment of a winding device that winds a blank recording tape around the reel (a winder device) is a complex operation.

### SUMMARY

The present invention has been devised in the circumstances described above, and an object of the present invention is to enable a reel, which is to be embedded in such a manner that the reel cannot be demounted from a drive device, to be easily attached to a winding device that winds round a blank recording tape.

To achieve the object described above, a reel of a first aspect according to the present invention includes: a substantially cylindrical bottomed reel hub, around an outer peripheral surface of which a recording tape is wound; a reel gear formed at a bottom section of the reel hub, the reel gear meshing with a drive gear of a winding device that winds the recording tape around the reel hub; and a stationary portion formed at the bottom section of the reel hub, the stationary portion being fixed by a fastener to a fastening portion formed at a rotating member of a drive device.

According to the aspect described above, the stationary section of the reel hub of the reel is fixed by the fastener to the fastening portion of the rotating member of a drive device. Therefore, the reel may be embedded such that the reel cannot be demounted from the drive device. During fabrication of the reel, when a blank recording tape is to be wound on the reel hub, the reel gear of the reel may be meshed with the drive gear of a winding device. Therefore, the reel may be easily attached to the winding device.

A reel of a second aspect according to the present invention further includes, in a reel of the aspect described above, a reel plate provided at the bottom section of the reel hub, the reel plate being attracted to a magnet of the winding device.

According to the aspect described above, during fabrication of the reel, when the blank recording tape is wound on the reel hub, the reel plate may be adhered by attraction to the magnet of the winding device. Therefore, the reel gear of the reel may be meshed with the driving gear of the winding device with better positional accuracy.

A reel of a third aspect according to the present invention further includes, in a reel of the aspects described above, a hole portion or indentation portion that is formed at a rotation center portion of the bottom section of the reel hub, and that centers the reel hub relative to the rotating member due to a protrusion portion, which is provided protruding from a rotation center portion of the rotating member, being inserted into the hole portion or indentation portion.

According to the aspect described above, the reel may be centered relative to the rotating member with better positional accuracy. That is, positional accuracy of the reel relative to the rotating member in a radial direction may be improved.

A reel of a fourth aspect according to the present invention further includes, in a reel of the aspects described above, an engaged portion that is formed at the bottom section of the reel hub on the circumference of a circle concentric therewith, and that positions the reel hub relative to the rotating member in a circumferential direction by an engaging portion, which is formed at the rotating member, engaging with the engaged portion.

According to the aspect described above, positional accuracy of the reel relative to the rotating member in the circumferential direction may be improved.

A reel of a fifth aspect according to the present invention further includes, in a reel of the aspects described above, a protrusion portion that is formed at the bottom section of the reel hub on the circumference of a circle concentric therewith, and that positions the reel hub relative to the rotating member in a height direction by abutting against the rotating member.

According to the aspect described above, positional accuracy of the reel relative to the rotating member in the height direction may be improved.

As described above, according to the present invention, a reel that is to be embedded in such a manner that the reel cannot be demounted from a drive device may be easily attached to a winding device that winds blank recording tapes.

### BRIEF DESCRIPTION OF THE DRAWINGS

An exemplary embodiment of the present invention will be described in detail based on the following figures, wherein:

FIG. 1 is a schematic perspective diagram showing a reel embedded in a drive device;

FIG. 2 is a schematic perspective diagram showing a rotating member of the drive device and the reel;

FIG. 3 is a schematic perspective diagram showing the reel fixed to the rotating member of the drive device; and

FIG. 4 is a schematic perspective diagram showing a bottom of a reel hub and a drive gear of a winding device to which the reel is attached.

### DETAILED DESCRIPTION

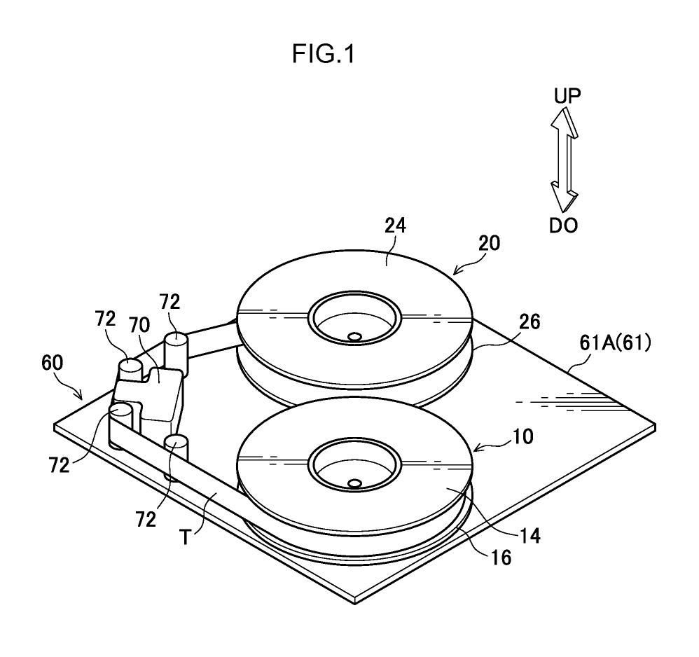

Herebelow, an exemplary embodiment according to the present invention is described in detail in accordance with the attached drawings. For convenience of description, arrow UP in FIG. 1 represents an upward direction, arrow DO represents a downward direction, and a rotation axis direction of reels 10 and 20 according to the present exemplary embodiment represents an up-and-down direction (a height direction).

The reels 10 and 20 according to the present exemplary embodiment are fabricated of a synthetic resin such as, for example, polycarbonate (PC) or the like. As shown in FIG. 1, the reels 10 and 20 are provided as a pair inside a casing 61 of a drive device 60 (only a bottom plate 61A of the casing 61 is shown in FIG. 1).

The reel 10 is for feeding out a recording tape T, which is described below, and the reel 20 is for winding up this below-described recording tape T. While the recording tape T is fed out from the reel 10 and wound onto the reel 20, the recording tape T slides against a recording/replay head 70. Thus, data is recorded onto the recording tape T by the recording/replay head 70 and/or data recorded on the recording tape T is replayed by the recording/replay head 70.

A plural number of tape guides 72 (a total of four in sets of two in the structure in the drawing) are rotatably provided at the bottom plate 61A, at both sides of the recording/replay head 70. The recording tape T being unwound from the reel 10 and wound onto the reel 20 is guided by the tape guides 72.

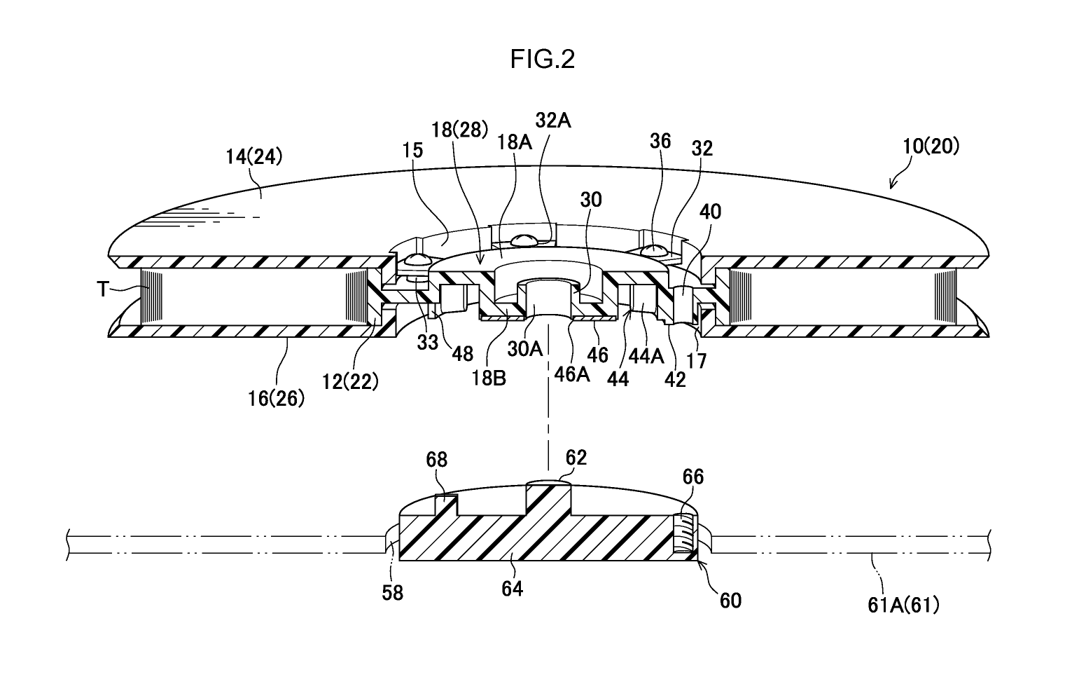

As shown in FIG. 2 to FIG. 4, the reel 10 includes a substantially cylindrical reel hub 12 that constitutes an axial center portion, an annular upper flange 14 that is provided at an upper end portion side of the reel hub 12, an annular lower flange 16 that is provided at a lower end portion side of the reel hub 12, and a bottom section 18 that is continuously provided integrally with an inner peripheral surface of the reel hub 12, at a substantially central portion thereof in the height (axis) direction.

Similarly, the reel 20 includes a substantially cylindrical reel hub 22 that constitutes an axial center portion, an annular upper flange 24 that is provided at an upper end portion side of the reel hub 22, an annular lower flange 26 that is provided at a lower end portion side of the reel hub 22, and a bottom section 28 that is continuously provided integrally with an inner peripheral surface of the reel hub 22, at a substantially central portion thereof in the height (axis) direction.

The recording tape T, which is a magnetic tape or the like serving as an information recording/replay medium, is wound around outer peripheral surfaces of the reel hubs 12 and 22. Width direction end portions of the wound recording tape T are respectively retained by the upper flanges 14 and 24 and the lower flanges 16 and 26.

The meaning of the term “substantially cylindrical” as used in the present invention includes a generally cylindrical shape in which the shape of an outer peripheral surface (winding surface) of the reel hub 12 or 22 around which the recording tape T is wound is a drum-like convex cylinder shape or the like, and a hollow shape that is not a complete cylinder, in which ribs or the like are provided protruding at the inner peripheral surface side of the reel hub 12 or 22.

Herebelow, because the reel 20 has the same structure as the reel 10, the reel 10 is mainly described. A cylinder portion 15 is integrally formed extending downward by a predetermined height from an inner periphery edge portion of the upper flange 14. A cylinder portion 17 is integrally formed extending upward by a predetermined height from an inner periphery edge portion of the lower flange 16.

Flat plate-shaped projection portions 32 and 34 are formed at an inner peripheral surface of the cylinder portion 15 and an inner peripheral surface of the cylinder portion 17. The projection portions 32 and 34 protrude to the respective radial direction inner sides (a rotation center portion of the reel 10). The projection portions 32 and 34 are formed in plural numbers (for example, six of each) with equal spacings, at positions that do not overlap with one another in plan view. Respective circular hole portions 32A and 34A are formed in the projection portions 32 and 34.

Cylindrical screw boss portions 33 and 35 are provided protruding from an upper surface and a lower surface at the outer peripheral edge portion side of the bottom section 18 of the reel hub 12 (at the inner peripheral surface side of the reel hub 12) Inner peripheral surfaces of the screw boss portions 33 and 35 are cut with female threads. The screw boss portions 33 and 35 are provided in plural numbers (for example, six of each) with equal spacings, at positions that they do not overlap with one another in plan view. The screw boss portions 33 and 35 and the hole portions 32A and 34A of the projection portions 32 and 34 are formed so as to communicate with one another.

Hence, screws 36 that are inserted into the hole portions 32A of the projection portions 32 of the upper flange 14 from above are threaded into the screw boss portions 33, and screws 36 that are inserted into the hole portions 34A of the projection portions 34 of the lower flange 16 from below are threaded into the screw boss portions 35. Thus, the upper flange 14 and the lower flange 16 are each integrally attached to the reel hub 12.

Three screw hole portions (stationary sections) 40 are formed at equal spacings on the circumference of a circle that is concentric with the bottom section 18, at the radial direction inner side relative to the cylinder portion 15 and the cylinder portion 17 (between particular screw boss portions 33 and 35 in plan view). The screw hole portions 40 are for fixing the bottom section 18 to a rotating member 64 of the drive device 60, which is described below. Protrusion portions 42 that protrude downward in tubular shapes are integrally formed at lower surface sides of the screw hole portions 40 on the circumference of the circle concentric with the bottom section 18, and are coaxial with the screw hole portions 40 (communicating with the screw hole portions 40).

An annular upper surface portion 18A is formed at the bottom section 18 at the radial direction inner side relative to the screw hole portions 40 (and the screw boss portions 33 and 35). The annular upper surface portion 18A protrudes upward to such an extent as not to protrude beyond an upper surface of the upper flange 14 in side view. An annular lower surface portion 18B is formed at the bottom section 18 at the radial direction inner side relative to the annular upper surface portion 18A. The annular lower surface portion 18B protrudes downward to such an extent as not to protrude beyond a lower surface of the lower flange 16 in side view.

A small cylindrical portion 30 is formed at a central portion of the bottom section 18 (at the rotation center portion of the reel 10), at the radial direction inner side relative to the annular lower surface portion 18B. The small cylindrical portion 30 protrudes upward to such an extent as not to protrude upward beyond the annular upper surface portion 18A in side view. A shaft portion (protrusion portion) 62 of the drive device 60 and a shaft portion 52 of a winding device 50, which are described below, can be inserted into (fitted into) a hole portion 30A in the small cylindrical portion 30.

At the lower surface side of the annular upper surface portion 18A, a reel gear 44 is formed in an annular shape at a radial direction outer side portion of the annular upper surface portion 18A. The reel gear 44 is constituted by plural upright ribs 44A extending in the height (axis) direction. The reel gear 44 is meshable with plural upright ribs 54A of a drive gear 54 of the below-described winding device 50.

Three indentation portions (engaged portions) 48 are formed with equal spacings at predetermined positions (on the circumference of the circle concentric with the bottom section 18) between the upright ribs 44A (so as to be disposed midway between the screw hole portions 40). Protrusion portions (engaging portions) 68 of the below-described rotating member 64 fit into the indentation portions 48. A reel plate 46, which is formed of a magnetic metal in an annular shape, is fixed by insert-molding to the annular lower surface portion 18B that is formed at the radial direction inner side relative to the reel gear 44.

A hole portion 46A that is formed in a central portion of the reel plate 46 is formed so as to communicate with the hole portion 30A of the small cylindrical portion 30. An inner diameter of the hole portion 46A is the same as or slightly greater than an inner diameter of the hole portion 30A. Hence, the below-described shaft portion 62 of the drive device 60 and the shaft portion 52 of the winding device 50 are insertable through this hole portion 46A into the hole portion 30A.

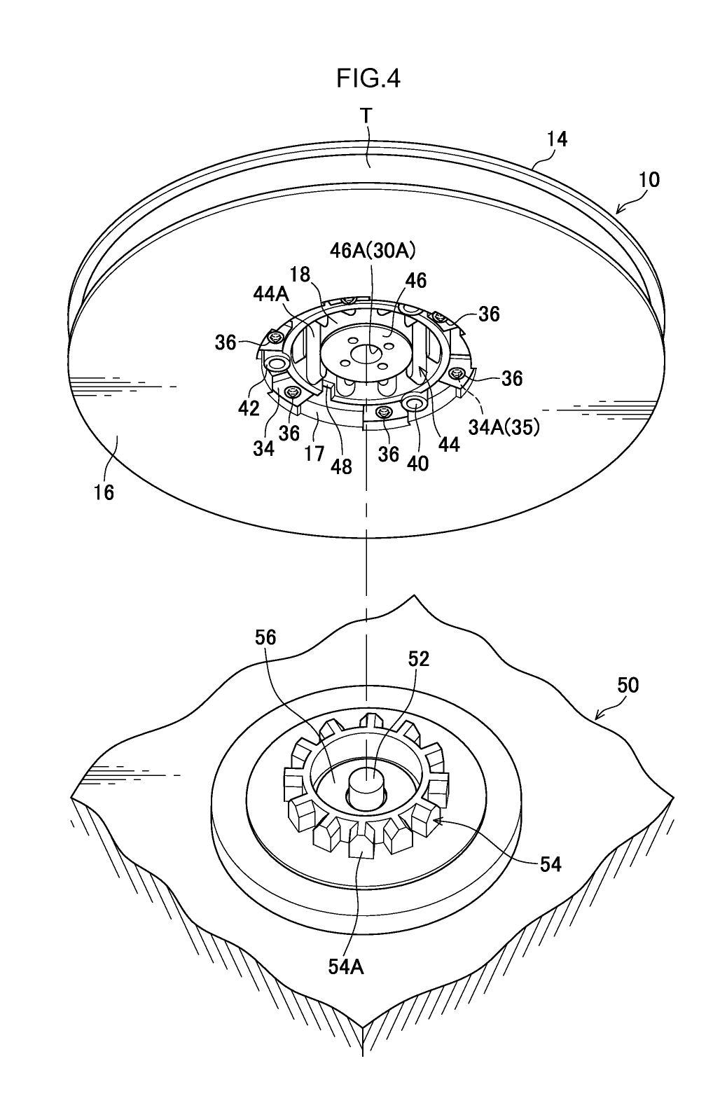

As described above, the drive gear 54 of the winding device 50 is meshable with the reel gear 44 of the reel 10. That is, as shown in FIG. 4, the drive gear 54 features the plural upright ribs 54A extending radially to the radial direction outer side, and the cylindrical shaft portion 52 is provided protruding upward from a rotation center portion of the drive gear 54. Further, an annular magnet 56 is fixed at the radial direction outer side relative to the shaft portion 52, at the radial direction inner side relative to the drive gear 54.

Therefore, during fabrication of the reel 10, when a blank recording tape T is to be wound around the outer peripheral surface of the reel hub 12, the shaft portion 52 is inserted through the hole portion 46A into the hole portion 30A, the reel plate 46 is adhered by attraction by the magnet 56, and the drive gear 54 meshes with the reel gear 44. Hence, the blank recording tape T is wound around the reel hub 12 of the reel 10 by the drive gear 54 of the winding device 50 turning.

Now, at the drive device 60 as shown in FIG. 2, a motor that serves as a drive source (not shown in the drawings) is provided. Rotary driving force is transmitted from a rotary shaft (not shown in the drawings) through a transmission gear (not shown in the drawings) to a pair of the rotating member 64. The rotating members 64 are respectively rotatably provided in a pair of aperture portions 58 formed in the casing 61 (bottom plate 61A) of the drive device 60.

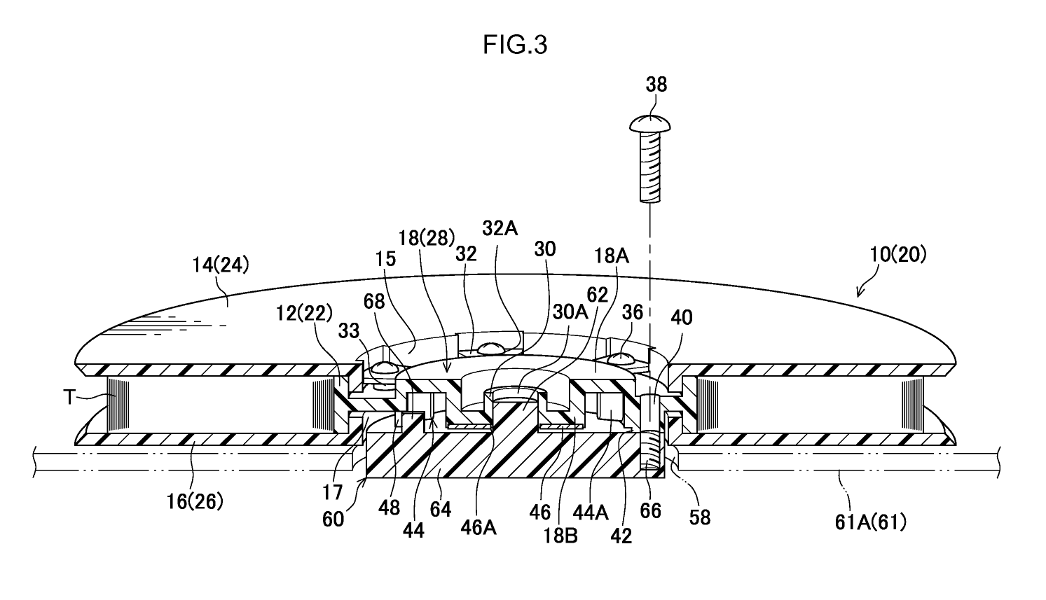

The bottom sections 18 and 28 of the reel hubs 12 and 22 of the reels 10 and 20 are fixed to the rotating members 64 by screws (fasteners) 38 shown in FIG. 3. That is, three screw boss portions (fastening portions) 66 are formed with equal spacings on the circumference of a circle concentric with each rotating member 64. The screws 38 are inserted into the screw hole portions 40 of the bottom sections 18 and 28 and are threaded into the screw boss portions 66.

Three of the protrusion portions 68 are provided protruding from each rotating member 64 with equal spacings so as to be disposed midway between the screw boss portions 66. The protrusion portions 68 fit into the indentation portions 48 formed in the bottom sections 18 and 28 of the reel hubs 12 and 22. The shaft portion 62 is provided protruding upward from a central portion (rotation center portion) of each rotating member 64. Each shaft portion 62 is inserted through the hole portion 46A of the reel plate 46 into the hole portion 30A of the bottom section 18 or 28 (the small cylindrical portion 30).

Thus, when the reel 10, around which the recording tape T is wound, and the reel 20, at which a free end of the recording tape T is attached to the outer peripheral surface of the reel hub 22, are fixed to the rotating members 64 of the drive device 60, the shaft portions 62 are inserted through the hole portions 46A into the hole portions 30A. By the protrusion portions 68 being fitted into the indentation portions 48, positions of the screw hole portions 40 and the screw boss portions 66 are matched up. The screws 38 are inserted into the screw hole portions 40 from above and are threaded into the screw boss portions 66. Thus, the reel hubs 12 and 22 and the rotating members 64 are integrally fixed.

Now, operation of the reels 10 and 20 with the structures described above is described. First, during fabrication of the reel 10, when the blank recording tape T is to be wound around the outer peripheral surface of the reel hub 12, the reel 10 around which the recording tape T has not been wound is attached to the winding device 50. That is, the drive gear 54 of the winding device 50 is caused to mesh with the reel gear 44 of the reel 10.

At this time, the shaft portion 52 of the winding device 50 passes through the hole portion 46A of the reel plate 46 and is inserted into the hole portion 30A of the bottom section 18 (the small cylindrical portion 30). The magnet 56 of the winding device 50 attracts the reel plate 46. Thus, the reel gear 44 of the reel 10 meshes with the drive gear 54 of the winding device 50 with good positional accuracy.

When the reel gear 44 and the drive gear 54 have been meshed with good positional accuracy, a free end of the blank recording tape T is attached to the outer peripheral surface of the reel hub 12. Then, by the drive gear 54 being rotated one way at high speed, the blank recording tape T is wound around the reel hub 12 of the reel 10.

When the blank recording tape T has been wound around the reel hub 12 of the reel 10 in this manner, the reel 10 is detached from the winding device 50 (the reel gear 44 is detached from the drive gear 54), and a trailing end side free end of the recording tape T is attached to the outer peripheral surface of the reel hub 22 of the reel 20.

Then, the reel 10 and reel 20 are embedded inside the drive device 60 (the casing 61). The bottom section 18 of the reel hub 12 of the reel 10 is fixed at one rotating member 64, and the bottom section 28 of the reel hub 22 of the reel 20 is fixed at the other rotating member 64.

That is, the shaft portion 62 of each rotating member 64 passes through the hole portion 46A of the reel plate 46 of the reel 10 or 20, and is inserted into the hole portion 30A of the bottom section 18 or 28 (the small cylindrical portion 30). Thus, radial direction positions of the reel hubs 12 and 22 (the bottom sections 18 and 28) relative to the rotating members 64 are accurately positioned (centered).

The protrusion portions 68 of the rotating members 64 are fitted into the indentation portions 48 formed in the bottom sections 18 and 28 of the reel hubs 12 and 22. Thus, circumferential direction positions (rotation angles) of the reel hubs 12 and 22 (the bottom sections 18 and 28) relative to the rotating members 64 are accurately positioned, and the positions of the screw hole portions 40 in the bottom sections 18 and 28 of the reel hubs 12 and 22 and the screw boss portions 66 of the rotating members 64 are matched up.

When the positions of the screw hole portions 40 and the screw boss portions 66 have been matched up, the screws 38 are inserted into the screw hole portions 40 and threaded into the screw boss portions 66. At this time, the protrusion portions 42 formed at (provided protruding from) the lower surfaces of the screw hole portions 40 abut against upper surfaces of the rotating members 64. Therefore, the reels 10 and 20 (the bottom sections 18 and 28 of the reel hubs 12 and 22) are fixed with positions thereof in the height (axis) direction having been accurately positioned.

Thus, in the present exemplary embodiment, the reel gear 44 formed at the bottom section 18 of the reel 10 and the reel plate 46 provided at the bottom section 18 are utilized when the blank recording tape T is being wound around the reel 10, and the screw hole portions 40 formed at the bottom section 18 of the reel 10 are utilized when the reel 10 is being fixed to the rotating member 64 of the drive device 60.

Therefore, the reel 10 according to the present exemplary embodiment may be easily attached to (and detached from) the winding device 50, and may be embedded to not be demountable from the drive device 60, with good positional accuracy. There is little likelihood of a recording tape T being wound around the reel 20 that is for unwinding. Therefore, the reel gear 44 and reel plate 46 need not be provided at the reel 20 for unwinding.

Hereabove, the reels 10 and 20 according to the present exemplary embodiment are described on the basis of the examples illustrated in the drawings, but the reels 10 and 20 according to the present exemplary embodiment are not to be limited to the illustrated example, and the design thereof may be suitably modified within a technical scope that does not depart from the spirit of the present invention. For example, rather than the hole portion 30A (small cylindrical portion 30) being formed at the central portions of the bottom sections 18 and 28 of the reel hubs 12 and 22 (the rotation center portions of the reels 10 and 20), a recess portion (not shown in the drawings) may be formed.

Further, the indentation portions 48 may be formed as engaging portions at the rotating member 64 and the protrusion portions 68 may be formed as engaged portions at the bottom sections 18 and 28 of the reel hubs 12 and 22, so as to perform positioning in the circumferential direction (to match up the positions of the screw hole portions 40 and the screw boss portions 66). Furthermore, the numbers of the indentation portions 48 (and the protrusion portions 68) and of the screw hole portions 40 (and the screw boss portions 66) are not limited to threes. The protrusion portions 42 are not limited to being formed coaxially with the screw hole portions 40 at the lower surfaces of the screw hole portions 40, and may be formed at the lower surface of the bottom section 18 on the circumference of a different concentric circle than the screw hole portions 40.

The disclosures of Japanese Patent Application No. 2010-172790 are incorporated into the present specification by reference in their entirety. All references, patent applications and technical specifications cited in the present specification are incorporated by reference into the present specification to the same extent as if the individual references, patent applications and technical specifications were specifically and individually recited as being incorporated by reference.

What is claimed is:

1. A reel comprising:
a substantially cylindrical bottomed reel hub, around an outer peripheral surface of which a recording tape can be wound;
a reel gear that is formed at a bottom section of the reel hub and is configured to mesh with a drive gear of a winding device that winds the recording tape around the reel hub; and
a stationary portion that is formed at the bottom section of the reel hub and is configured to be fixed by a fastener to a fastening portion formed at a rotating member of a drive device.

2. The reel according to claim 1, further comprising a reel plate that is provided at the bottom section of the reel hub and is configured to be attracted to a magnet of the winding device.

3. The reel according to claim 1, further comprising a hole portion or indentation portion that is formed at a rotation center portion of the bottom section of the reel hub, and that centers the reel hub relative to the rotating member due to a protrusion portion, that is provided protruding from a rotation center portion of the rotating member, being inserted into the hole portion or indentation portion.

4. The reel according to claim 1, further comprising an engaged portion that is formed at the bottom section of the reel hub on the circumference of a circle concentric therewith, and that positions the reel hub relative to the rotating member in a circumferential direction by an engaging portion, that is formed at the rotating member, engaging with the engaged portion.

5. The reel according to claim 1, further comprising a protrusion portion that is formed at the bottom section of the reel hub on the circumference of a circle concentric therewith, and that positions the reel hub relative to the rotating member in a height direction by abutting against the rotating member.
